(19) United States
(12) Patent Application Publication
(10) Pub. No.: US 2018/0370060 A1
(43) Pub. Date: Dec. 27, 2018

(54) ROTARY CUTTER WITH KNIFE HOLDER

(71) Applicant: Vits International, Inc., Blauvelt, NY (US)

(72) Inventors: John Salamone, Blauvelt, NY (US); Gregory Balcerek, Blauvelt, NY (US)

(21) Appl. No.: 15/985,084

(22) Filed: May 21, 2018

Related U.S. Application Data
(60) Provisional application No. 62/509,155, filed on May 21, 2017.

(51) Int. Cl. B26D 7/26; B26D 1/24

(52) U.S. Cl. CPC B26D 7/2635; B26D 1/24; B26D 7/2621

(57) ABSTRACT

A method and device for setting the height of a knife blade in a cylinder of a rotary cutter is provided. The cylinder includes an aperture that is sized and shaped to receive a wedge block therein and seated adjacent a footing surface within the aperture. At least one or both of the footing surface or bottom surface of the wedge block are angled such that side-to-side movement of the wedge block within the aperture will cause a knife blade seated on a top surface of the wedge block to move vertically with respect to the outer surface of the cylinder. As such, side-to-side movement of the wedge block provides for a precise and reliable means for adjusting and setting the height of the knife blade.

### CROSS REFERENCE TO RELATED APPLICATIONS

This patent application claims the benefit of priority under 35 U.S.C. Section 119(e) from U.S. Provisional Application Ser. No. 62/509,155, filed on May 21, 2017 and titled “Rotary Cutter with Knife Holder,” which is hereby incorporated by reference in its entirety.

### FIELD OF THE INVENTION

The present invention relates to equipment used in the processing of material (e.g. web material), and, more particularly, to a rotary cutter.

### BACKGROUND

Rotary cutters are used in the printing industry to sever and perforate, as the case may be, moving web materials such as paper. Incisions are generally made transverse to the direction of web travel, and serve to separate the web into discrete predetermined lengths or create tear lines at predetermined locations along the length of the web. A rotary cutter typically comprises a pair of synchronized counter-rotating knife and anvil cylinders between which the web passes. The knife cylinder is equipped with one or more knife blades (or knives) that generally extend parallel to the rotational axis of the knife cylinder, and cut or perforate the web against the anvil cylinder. In known web-type printing press operations that produce a printed product from a moving paper web, the printed product may pass through other auxiliary equipment performing additional operations before being forwarded to the rotary cutter. A single knife blade can be mounted to the knife cylinder to produce what has been termed a butt cut in web material. Mounting a pair of knife blades circumferentially adjacent each other produces what has been termed a bleed cut, resulting in a trim piece or chip being formed that must be discarded.

Because the circumference of a knife cylinder is fixed, the lengths of the segments into which a web can be cut are varied by changing the circumferential locations of multiple knife blades mounted to the knife cylinder, resulting in multiple cuts being produced in the web with each revolution of the knife cylinder. Rotary cutters designed to be reconfigurable for processing various different products are referred to as variable product rotary cutters, or simply variable rotary cutters. Virtually all variable rotary cutters utilize knife holders (or knife blocks) that house the knife blades. “Make-ready” is a term of art that is understood to mean the process of setting up a rotary cutter by mounting knife holders to a knife cylinder before running a job.

One configuration of a variable rotary cutter employs knife holders mounted to the knife cylinder by a dovetail lock-up design in the surface of the cylinder face. In another configuration, multiple tapped holes are formed in the surface of the cylinder face to clamp knife holders onto the cylinder. Knife holder sizes are matched to the lengths of the knife blade with which they are to be used, and knife blades are mounted in their respective holders off the cutting machine. During make-ready, the operator must know the format of the finished product including the final product length, the number of product streams that will simultaneously pass through the rotary cutter, and the width of each stream. In addition, it is important to know where these streams will be relative to the centerline (axial midpoint) of the cylinder, i.e., left or right of the centerline. Two product streams side-by-side with widths of less than 12 inches (about 30 cm) are most common, in which case two 12-inch holders, each carrying a 12-inch knife blade, would be used.

Once the above information is retrieved, the knife holders are mounted in the strategic locations both circumferentially and axially on the cylinder surface to produce the desired products. Proper positioning of the knife holders requires a locating device and indexing of the cylinder. The knife cylinder is rotated until a location at which a knife blade is required is accessible to the operator. A knife holder (with a mounted knife blade) is placed on the cylinder and its location precisely determined with the locating device. The holder is then secured to the cylinder, after which the cylinder is again indexed to the next location requiring a knife blade. This process is repeated for each knife holder, resulting in a very tedious and time-consuming process.

When the particular job is finished and a new job with a different product format is to be run, all of the knife holders are removed from the cylinder and the entire process is repeated. On occasion, the product lengths might be the same from job to job, however the product stream width and/or location (left or right) often differ, requiring the holders to be removed and remounted left or right to line up with the printed streams.

In other rotary cutters, the knife cylinder has a plurality of knife holders circumferentially positioned about the circumference of the knife cylinder. At least some of the knife holders extend the axial length of the knife cylinder and are configured to permit multiple knife blades of different lengths to be mounted therein end-to-end across the entire axial length of the knife cylinder. At least one knife blade can be mounted in at least a first of the knife holders, while knife blades are not mounted in at least a second of the knife holders so that rotation of the knife cylinder against a web material forms incisions spaced apart a first spacing distance in the web material. Thereafter, the knife cylinder can be reconfigured without repositioning any of the knife holders on the knife cylinder, but instead by removing, repositioning, and/or installing knife blades on the knife holders. An example of such a device can be found in US Patent Application Publication No. 2005/0247174 to Scheffer, et al., which is incorporated by reference herein in its entirety.

As discussed above, typical rotary cutters include two cylinders that rotate relative to each other. Knife blades are mounted to one cylinder and the other cylinder acts as an anvil that provides a surface against which to sandwich the web material between the knife blade to perform the cut.

### SUMMARY OF THE INVENTION

According to an aspect of the invention, a rotary cutter with a knife holder is provided. The rotary cutter includes a cylinder having an outer surface and having an aperture defined about a perimeter of the cylinder. The aperture is defined by a bearing wall, a backing wall, and a footing surface. A wedge block having a top face and a bottom face is disposed in the aperture with the bottom face of the wedge block seated adjacent the footing surface. At least one of the bottom face of the wedge block is angled with respect to the top face such that the bottom face and the top face are non-parallel, or the footing surface is angled with respect to the backing wall such that the foot surface and the backing wall are non-perpendicular. As such, movement of the wedge block side-to-side with respect to the backing wall within the aperture is configured to cause a knife blade seated on the top surface of the wedge block to move vertically with respect to the outer surface of the cylinder.

In accordance with a further aspect, the bottom face of the wedge block and the footing surface are angled.

In accordance with yet further aspect, an adjustment screw coupled to the wedge block is provided, wherein rotation of the adjustment screw is configured to cause side to side motion of the wedge block with respect to the backing wall.

In accordance with a further aspect, the aperture further includes a recess and a well, wherein the recess and the well define areas to receive at least a portion of the wedge block in side-to-side adjustment positions.

In accordance with still further aspect, the well extends horizontally and downwardly from the footing surface.

In accordance with a further aspect, the recess extends horizontally and at least upwardly from the footing surface.

In accordance with a further aspect, the wedge block further includes an elongated hole sized and shaped to receive a fastener, wherein the elongated holes permit side-to-side movement of the wedge block in a first adjustment condition, and wherein the fastener is configured to secure the wedge block from movement in a second set condition.

In accordance with another aspect, a method of setting a knife height in a cylinder of a rotary cutter is provided. The method includes the steps of inserting a wedge block into an aperture in the cylinder. The wedge block has a top face and a bottom face, and the aperture is defined a bearing wall, a backing wall, and a footing surface. At least one of the bottom face of the wedge block is angled with respect to the top face such that the bottom face and the top face are non-parallel, or the footing surface is angled with respect to the backing wall such that the foot surface and the backing wall are non-perpendicular. The method further includes the step of seating the bottom face of the wedge block adjacent the footing surface of the aperture. The side-to-side position of the wedge block is adjusted with respect to the backing wall within the aperture to cause a knife blade seated on the top surface of the wedge block to move vertically with respect to the outer surface of the cylinder. The wedge block is secured within the aperture once a desired vertical position of the knife blade is achieved. The knife blade is secured within the aperture.

### BRIEF DESCRIPTION OF THE DRAWINGS

The accompanying drawing figures illustrate exemplary embodiments and are not intended to be limiting of the invention. Among the drawing figures, like references are intended to refer to like or corresponding parts.

FIG. 1 illustrates a side cross section view a rotary cutter system in accordance with at least one embodiment of the present application;

FIG. 2 illustrates a front view thereof;

FIG. 3 illustrates a left side view thereof;

FIG. 4 illustrates a right side view thereof;

FIG. 5 illustrates a top view thereof;

FIG. 6 illustrates a cross section view of the cylinders thereof;

FIG. 7 illustrates a close up view of FIG. 6;

FIG. 8A illustrates a top view of a wedge;

FIG. 8B illustrates is a rear view of the wedge;

FIG. 8C is a side view of the wedge;

FIG. 9A illustrates a cylinder; and

FIG. 9B is a close up view of the cylinder.

### DETAILED DESCRIPTION OF CERTAIN EMBODIMENTS OF THE INVENTION

The invention is now described with reference to the accompanying drawings, which form a part hereof, and which show, by way of illustration, example implementations and/or embodiments of the present invention. It is to be understood that other embodiments can be implemented and structural changes can be made without departing from the spirit of the present invention. Among other things, for example, the disclosed subject matter can be embodied as methods, devices, components, or systems.

Furthermore, it is recognized that terms may have nuanced meanings that are suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter can be based upon combinations of individual example embodiments, or combinations of parts of individual example embodiments.

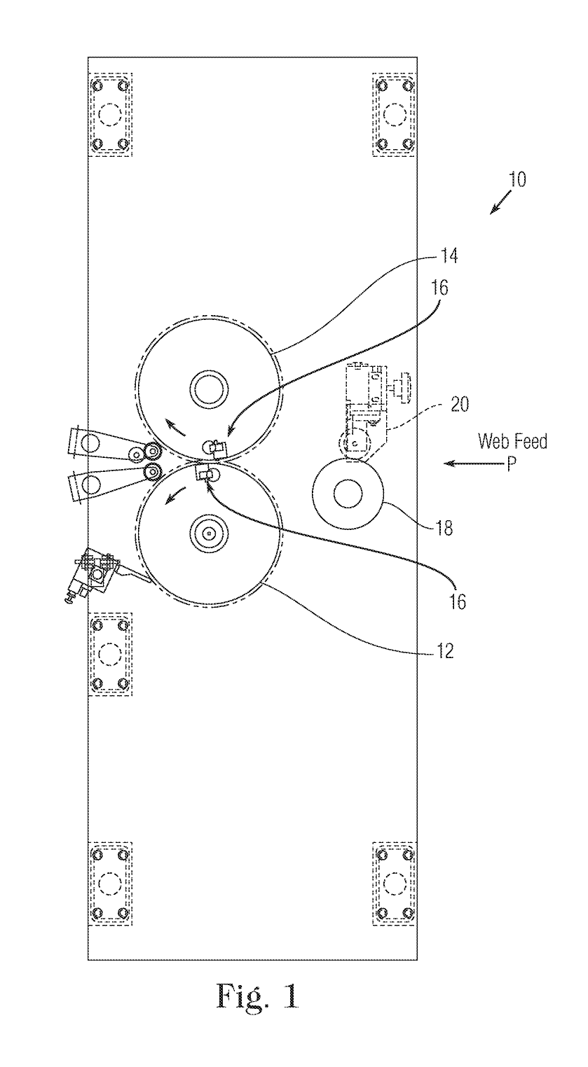

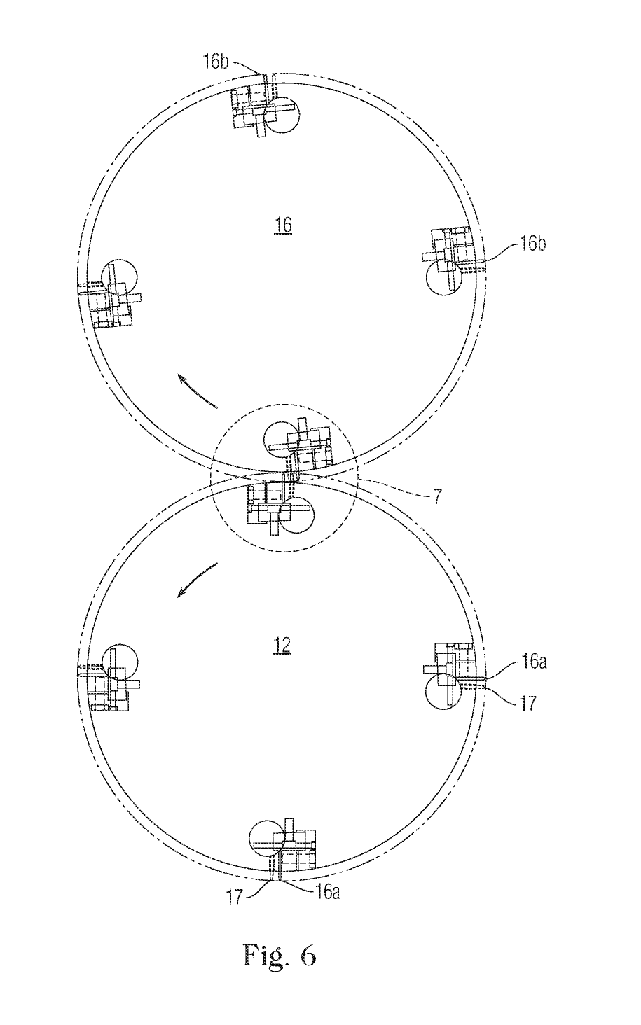

Referring to FIG. 1, a cross-sectional view of a rotary cutter 10 is shown. The rotary cutter 10 includes two cylinders 12 and 14. Each cylinder 12 and 14 includes a plurality of knife blades (e.g., four knife blades 16 arranged about each cylinder 12 and 14 as shown in FIG. 6). The knife blade 16 can have a chisel shaped tip (e.g., angled tip) that provides the cutting surface. The knives are received and secured in apertures 150 that hold the knives 16 perpendicular to their respective cylinders. The bottom cylinder 12 is slightly out of phase with top cylinder 14. Accordingly, as the cylinders rotate with respect to each other, the knives contact the other cylinder in alternating fashion. In FIG. 1, the blade 16 is contacting a portion of the top cylinder 14 in area of the cylinder that does not have a blade. Therefore, a web (not show) that is being feed between the cylinders would be cut by the knife of the bottom cylinder. As the cylinders continue to rotate the knife from the top cylinder will contact the bottom cylinder to perform a second cut. The distance between cuts defines the cuts in the web of material. Accordingly, by adjusting the rotation phase of the top cylinder relative to the bottom cylinder, the cut can be easily adjusted without repositioning the knives on the rotary cylinder. Adjusting the speed of rotation of the cylinders can adjust the size of the cut since the rotation speed relative the speed of travel of the web of material. U.S. patent application Ser. No. 13/609,247 (Pub. No. 2013/0118328), filed Sep. 10, 2012, which claims priority to U.S. Provisional Application Ser. No. 61/533,184, filed on Sep. 9, 2011, which are hereby incorporated by reference in their entireties, discloses a rotary cutter system that includes knife blades on upper and lower cylinders wherein adjusting the speed of rotation of the cylinder relative to the web speed can adjust the size of the cut in the web of material. As discussed in more detail below, the lower and upper cylinders 12, 14 are controlled by respective servo motors 200, 202. The rotation speed of both the lower and upper cylinders 12, 14 can be controlled by adjusting servo motors 200 and 202 (which can be centrally controlled) by a corresponding rate, which can be used to adjust the cut size of the piece of material.

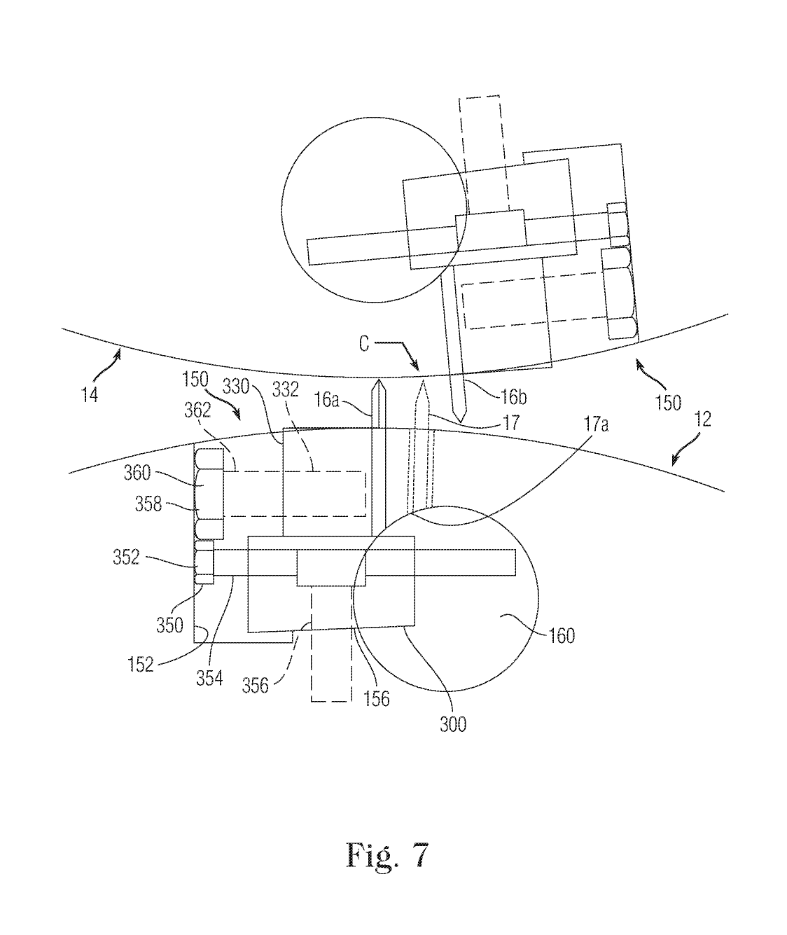

By providing knives on top and bottom cylinders of a rotary cutter, the length of the cuts can also be adjusted by adjusting the phase between the two cylinders. More particularly, by setting the phase difference between the top and bottom cylinders, the size of the piece of the web material that is cut between the bottom knife contacting the top cylinder and the top knife contacting the bottom cylinder can be controlled. The piece of web material is the trim piece or chip. Thus, the chip size can be adjusted by adjusting the phase difference between the top and bottom cylinders, without having to adjust the positioning of the knives. As can be seen in FIGS. 6 and 7, the space between the contact point of the bottom knife blade 16a with the upper cylinder 14 and the contact point of the upper knife blade 16b with the lower cylinder 12 defines the cut length of the chip piece. The distance between the contact points of corresponding upper and lower knife blades defines the chip cut space C between the upper and lower knife blades (pins 17 can be disposed along the cylinder and positioned to be between the contact points of the upper and lower knife blades to hold the material as it is being cut to form the chip). The distance between the contact points of corresponding upper and lower knife blades is defined by the phase difference between the lower and upper cylinders 12, 14. Accordingly, the phase difference between the upper and lower cylinders controls the chip size and adjusting the phase difference permits the chip size to be adjusted. As discussed in more detail below, since lower and upper cylinders 12, 14 are controlled by respective servo motors 200, 202, each servo can be controlled independently. For example, a phase control input can be sent to servo motors 200 and 202 so that the servos cause the lower and upper cylinders to rotate at different speeds with respect to each other, which causes a phase shift between the two cylinders. By adjusting the phase of the two cylinders, the distance between the contact points of the upper and lower knives can be changed, which changes the chip cut size. Since the upper and lower cylinders are controlled by separate servo motors, the phase between the lower and upper cylinders can be changed on the fly, during cutting operations. Accordingly, a continuous web of material can be fed into the rotary cutter and the chip size can be adjusted without having to stop operation of the cutting line to manually adjust the phase between upper and lower cylinders.

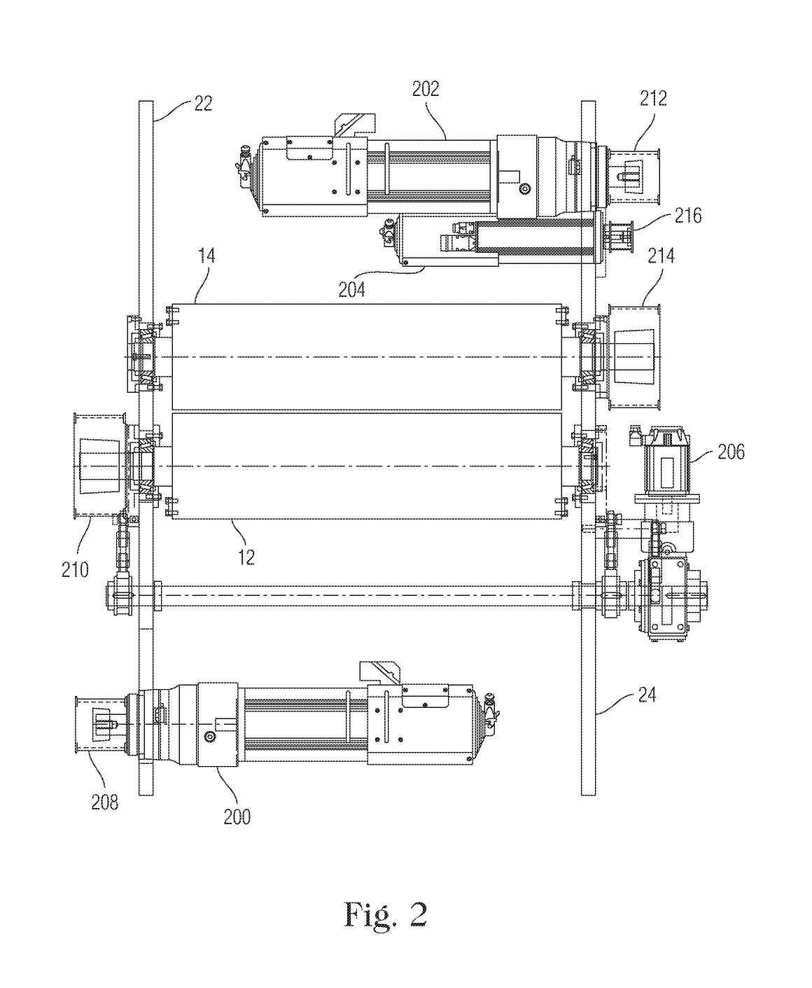

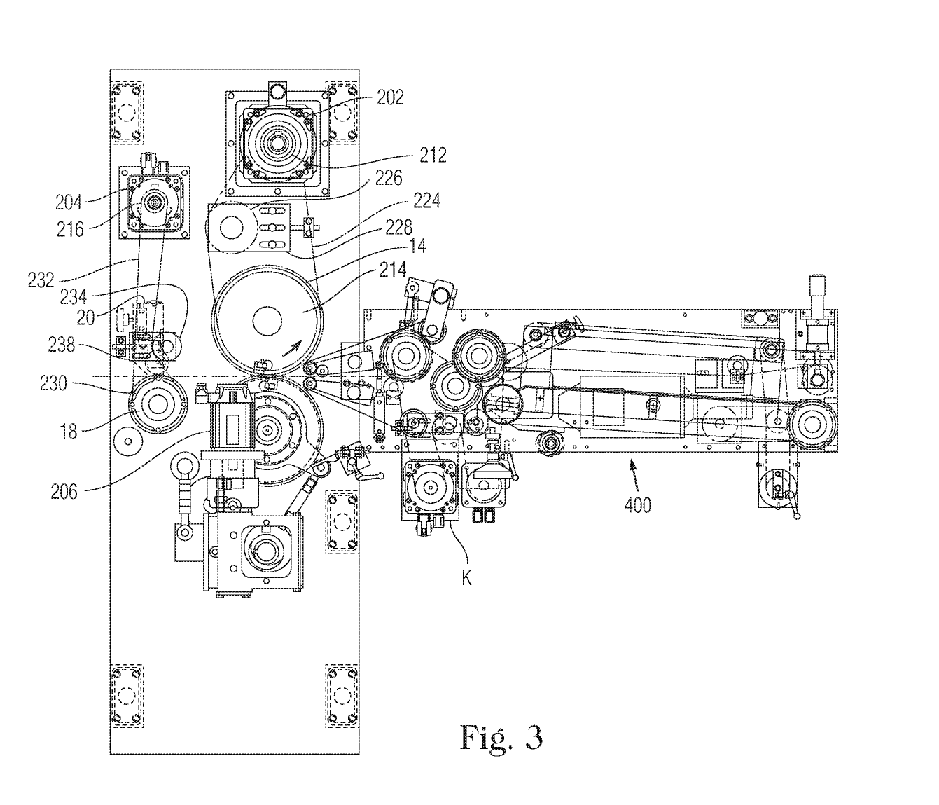

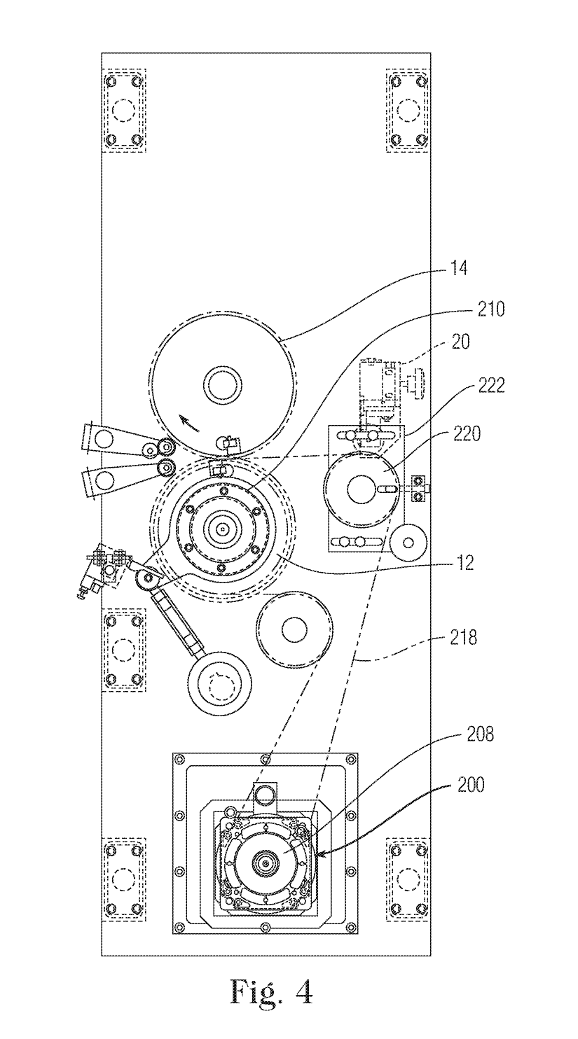

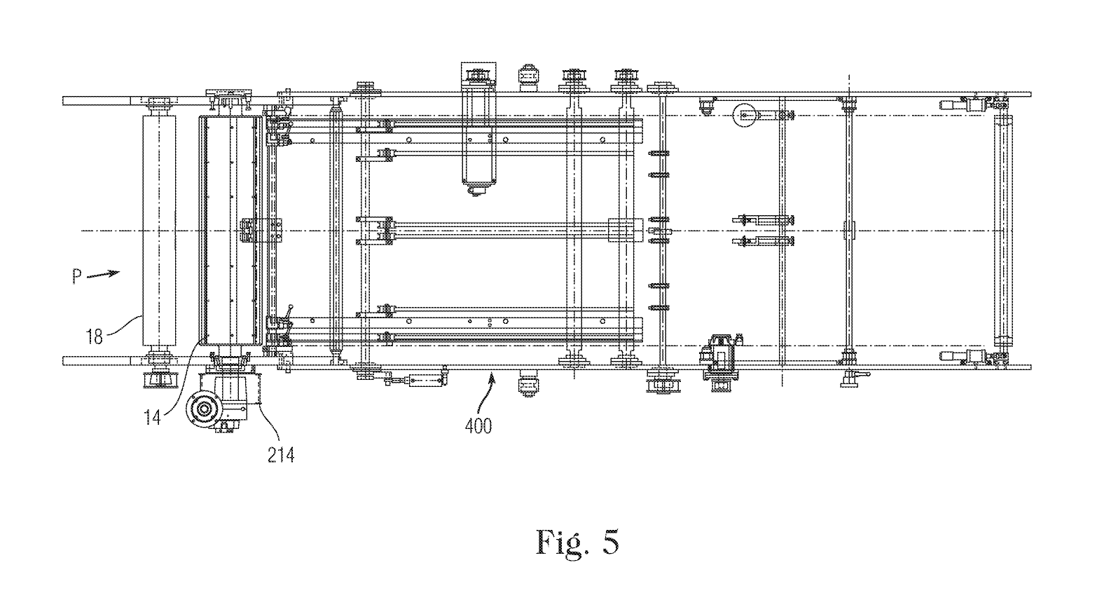

Referring FIGS. 2-4 to servo motors 200, 202, 204, and 206 are shown. Servo motor 200 drives the rotation of lower cylinder 12. A pulley 208 is connected to the servo motor 200 and a pulley 210 is connected to cylinder 12. A belt 218 extends between pulley 208 and pulley 210 so that the servo motor 200 can rotationally drive the cylinder 12. A pulley 220 mounted on a slidably adjustable tensioner block 222 can be used to maintain the desired tension in the belt 218.

Servo motor 202 drives the rotation of upper cylinder 14. A pulley 212 is connected to servo motor 202 and a pulley 214 is connected to upper cylinder 14. A belt 224 extends between pulley 212 and pulley 214 so that the servo motor 202 can rotationally drive the cylinder 14. A pulley 226 mounted on a slidably adjustable tensioner block 228 can be used to maintain the desired tension in the belt 224.

Servo motor 204 drives the rotation of an infeed draw roller 18. A pulley 216 is connected to servo motor 204 and a pulley 230 is connected to draw roller 18. A belt 232 extends between pulley 216 and pulley 230 so that the servo motor 204 can rotationally drive the draw roller 18. A pulley 234 mounted on a slidably adjustable tensioner block 238 can be used to maintain the desired tension in the belt 232. The material to be cut (arrow P) is feed over the top of the draw roller 18 (FIG. 2 shows the draw roller 18 out of position so that the lower and upper cylinders 12, 14 can be more clearly seen). Pneumatic trolleys 20 can be provided in conjunction with the draw roller 18 to assist with the feed of the material to be cut over the draw roller.

The lower cylinder 12 is mounted in eccentric housings driven by the height control servo 206 through a gearbox to adjust the height of the lower cylinder relative to the upper cylinder. Controlling the servo 206 causes the cylinder 12 to move within its eccentric housing so that the distance between the anvil cylinder 12 and the cutting cylinder 14 is adjusted either up or down, which ensures the upper and lower knives are contacting their respective, opposite cylinders properly.

Furthermore, adjusting the speed of rotation of the cylinder results in an adjustment of the piece of web material that is cut. As can be seen in FIG. 6, as the cylinders continue to rotate, they will rotate into a position in which neither the top or bottom knives are contacting either cylinder. In this state, the web material continues to pass between the two cylinders. Thus, if the cylinders are set to rotate slowly, more web material can pass between the cylinders before the next knife contacts and makes a cut. If the cylinders are rotating quickly, less web material can pass between the cylinders, resulting in smaller web pieces being cut.

Accordingly, by controlling the speed of servo motors 200 and 202, which controls the rotational speed of the two cylinders 12, 14 (e.g., using computer control), the size of the size of the cuts can be adjusted as required by the particular job. In addition, since the cylinders 12, 14 are controlled by separate servo motors, the cylinders 12, 14 can be rotated a differential amount relative to on another to alter the phase between the two cylinders, which can control the size of the chip cut. As such, adjusting the speed of servo motors 200 and 202 in a synchronous manner controls the size of the main cut (e.g., the printed material such as a catalog page or mailer, for example) and adjusting the servos motors 200 and 202 in a differential manner causes the cylinders to change phase, which controls the size of the chip cut (e.g., the trim or waste piece).

The rotary cuter 10 is designed to cut a long web of material, e.g., a spool of paper, into specific length sheets. The material can be stored on a spool and feed through a printing press system upstream of the cutter 10 that applies graphics to the paper. After the graphics have been applied, the stream of material from the press, shown with arrows P, is feed through the cutter 10 to be cut, as discussed in more detail below. The plurality of servo motors and cylinders of the rotary cutter 10 are supported between a pair of mounting walls 22, 24. The cutter 10 can be a part of a printing and processing line, wherein each station in the line (e.g., receiver 400 that is located down stream of cutter 10 and which handles the cut pieces that are cut by the rotary cutter 10 from the web of material) is controlled by additional servo motors (e.g., kicker motor K) that control various other functions along the line. The servo motors of the cutter 10 and the line servo motors can be centrally controlled so that the speed of operation of the various parts of the system can be controlled to execute different size cuts and/or to handle different sized cut material pieces downstream of the cutter 10.

The control system of the rotary cutter 10 includes a controller and a memory that can store software modules that are executed on the processor of the controller. A display and an interface allow for the operator to input settings, such as the thickness of the material to be cut, length of the cut to be made in the material, the number of knives that are in the machine, etc. The interface and display can be a touch screen-type interface and display. The control receives these variables and, through the software, determines how to control the various motors of the cutter and/or along the line (upstream and downstream). The controller, through the drivers, sends electrical signals to the various motors, such as the cylinder servo motor 200 and 202, the height control motor 206, and the draw servo motor 204. In addition, the controller receives signals from sensors (e.g., at various points along the line, including directly upstream of the cutter) that provide information concerning the current feed of the material to be cut. For example, the sensor can be an optical sensor that images printed registration marks on the material to be cut. As the registration marks are sensed, the controller receives a signal from the sensor and the controller, through software, can determine whether adjustments to the servos need to be to ensure that the material is being cut at the correct locations. The sensors can also include a press-feed sensor, i.e., a sensor that senses the speed of the material that is to be cut upstream of the cutter. The press-speed can then be used by the controller to adjust the speed of the draw servo so that the draw servo rotates to match the press-speed. This ensures a smooth feed from the upstream into the cutter.

After the material to be cut passes over the draw roller 18, it is passed between the lower and upper cylinders 12, 14. Both the upper and lower cylinders 12, 14 include cutting knives 16 as well as a surface for an opposing knife to contract to perform the cut. Accordingly, both the lower and upper cylinders function as cutting and anvil cylinders. The lower cylinder 12 can include four fixed extractor pins 17 positions spaced along the length of the cylinder (e.g., at 1″ intervals) that are used to remove material chips, i.e., scrap material that is disposed between two cut pieces of the material.

The tail of the product is knocked by kicker brushes so the product is controlled by the tail as it enters the slow down delivery. The kickers are servo driven (motor K) and can be phased to contact the tail of each sheet in the same position. The speed of the kickers can automatically set by the controller once the operators select product size. The slow down delivery is driven by a servo drive and the size of the shingle is adjusted from the operators touch screen.

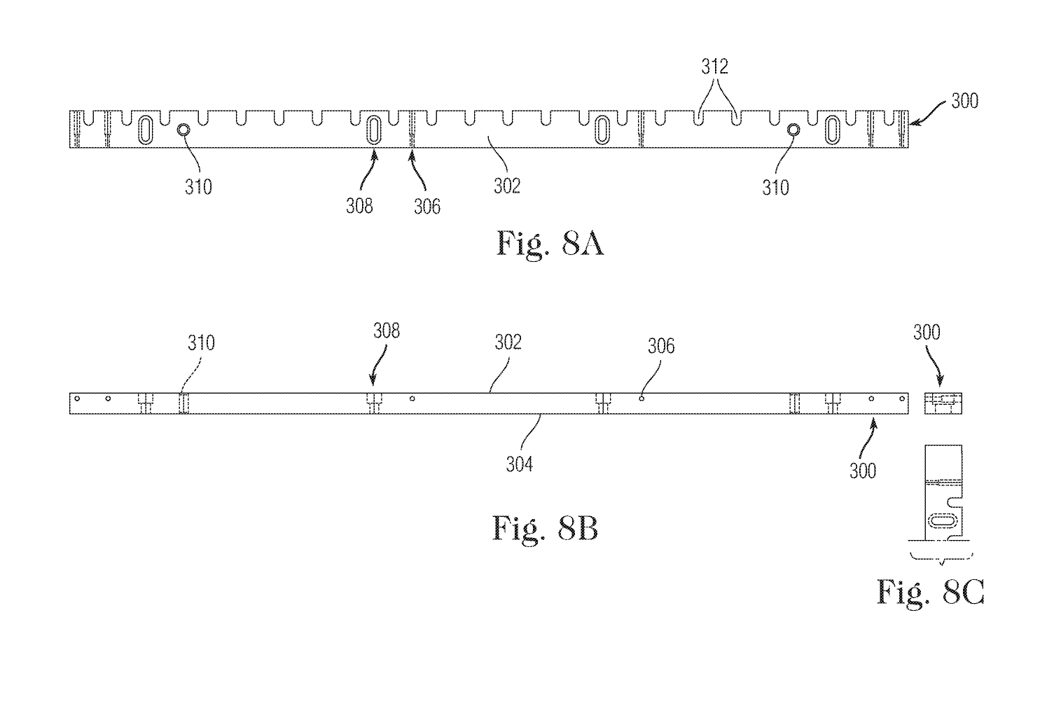

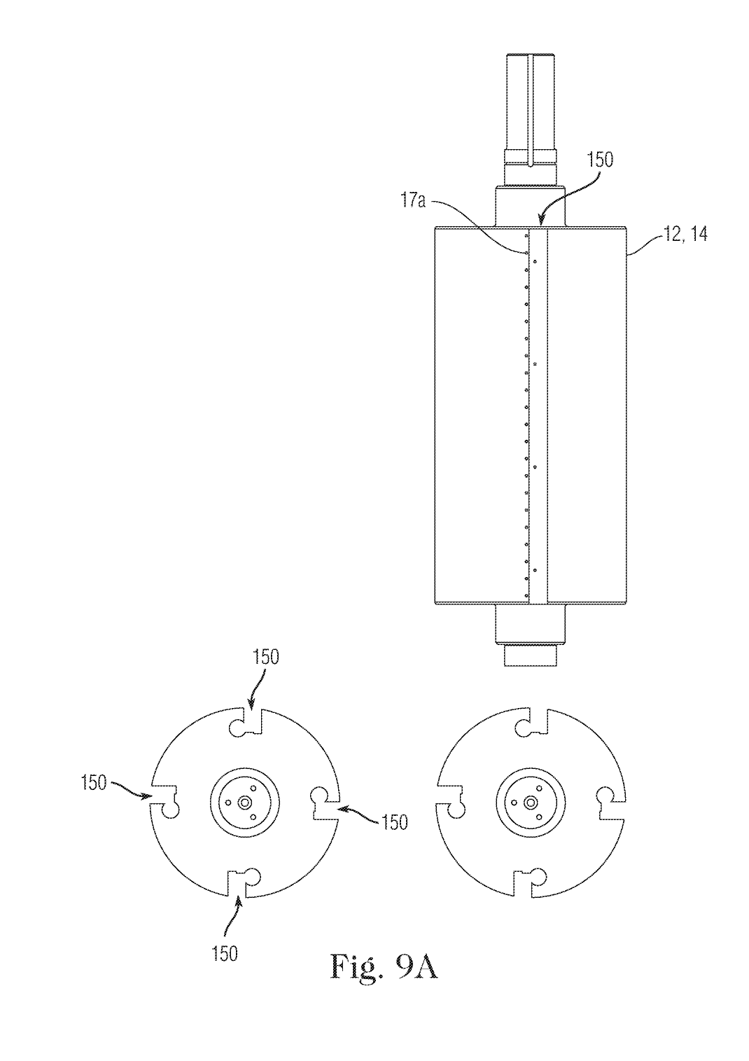

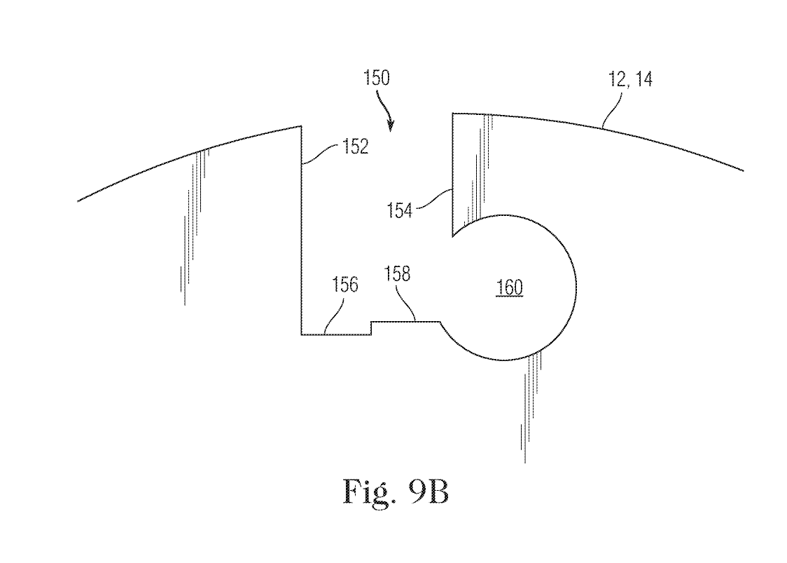

Referring to FIGS. 6-9, a system for adjusting and setting the height of the knife blades 16 is shown and, as disclosed herein, an exemplary method for adjusting and setting the height of the knife blades 16 is described. As discussed above, lower and upper cylinders 12, 14 include a number of apertures 150 (e.g., four apertures) disposed about the perimeter of the cylinders. Each aperture includes a bearing wall 152, a backing wall 154, a well 156, a wedge footing 158, and a recess 160. The bearing wall 152 and backing wall 154 are generally parallel to each other. The wedge footing 158 is slightly angled (e.g., 2 degrees) out of perpendicular with respect to the backing wall 154. The angle of the wedge footing 158 increases the effectiveness of the wedge block 300 to adjust the height of the knife 16, as discussed in more detail below.

An angled wedge block 300 is provided to adjust the height of the knife blade 16. The wedge block 300 has a top face 302 and a bottom face 304. The bottom face 304 of the wedge block is angled out of parallel with respect to the top face 302 of the wedge. The bottom face 304 seats against the wedge footing 158, which is also angled. The knife 16 is seated against the top face 302 of the wedge 300. Since the bottom face 304 and the wedge footing are angled, moving the wedge 300 side to side causes the knife blade 16 to move up and down. Moving the wedge block 300 toward the bearing wall 152 lowers the knife 16 and moving the wedge into the recess 160 causes the knife blade to move upward. The well 158 and recess 160 provide an area to accommodate the wedge as it is moved in the recess 150. A plurality of adjustment screws 350, which each includes a head 352 and a threaded shank 354, is provided to move wedge 300 side to side. The wedge 300 is provided with threaded holes 306 that are sized and shaped to receive the adjustment screws 350. The head 352 of the screw seats against the bearing wall 152 to horizontally fix the position of the head 352. Accordingly, rotating the screw 350, which is threadingly engaged with the wedge block 300, causes the wedge block to move side to side and hence the knife 16 to move up and down. As such, the height of the knife can be precisely adjusted by rotating the screw 350.

The wedge 300 is provided with elongated holes 308 that are sized and shaped to receiving mounting screw 356. Threaded holes are provided in the cylinder to receive the mounting screws 356. Accordingly, the mounting screws 356 can be used to hold the wedge 300 against the wedge sear 158 during side to side adjustment. The elongated holes 308 permit the wedge to move side to side during the adjustment phase. Once the knife is as the correct height, the screws 356 can be further tightened to hold the wedge in place. Once the knife is confirmed to be at the correct height and no further adjustments are required, the wedge can be semi-permanently fixed into place using set pins (not shown) that are inserted into holes 310 in the wedge and into the cylinder.

The knife 16 seats vertically against the wedge 300 to set the height, as discussed above. Once the height is set, the knife is held into place by sandwiching the knife between knife holder block 330 and the backing wall 154 of the aperture 150. A holder screw 358, which includes a head 360 and threaded shaft 362, is sized and shaped to be received within a threaded hole 332 in the block 330. Since the head of the screw 360 is abutted against the bearing wall 152, rotating the screw 358 causes the block 330 to move side to side via the threaded engagement. Accordingly, rotating the screw 358 causes the block 330 to move against the knife 16 to sandwich the knife between the block 330 and the backing wall 154 to lock the knife 16 in place.

As discussed above, pins 17 can be included and disposed in shafts 17a along the length of the cylinders. When the pins 17 need to be replaced (e.g., due to wear) they can be pushed downwardly in the recess 160 in their respective cylinders. Since the wedge block 300 may extend into the recess 160, the wedge block 300 is provided with a plurality of notches 312 that are sized and shaped and positioned so that the wedge 300 does not impede the pins 17 entering the recess 160.

Notably, the figures and examples above are not meant to limit the scope of the present application to a single implementation, as other implementations are possible by way of interchange of some or all of the described or illustrated elements. Moreover, where certain elements of the present application can be partially or fully implemented using known components, only those portions of such known components that are necessary for an understanding of the present application are described, and detailed descriptions of other portions of such known components are omitted so as not to obscure the application. In the present specification, an implementation showing a singular component should not necessarily be limited to other implementations including a plurality of the same component, and vice-versa, unless explicitly stated otherwise herein. Moreover, applicants do not intend for any term in the specification or claims to be ascribed an uncommon or special meaning unless explicitly set forth as such. Further, the present application encompasses present and future known equivalents to the known components referred to herein by way of illustration.

The foregoing description of the specific implementations will so fully reveal the general nature of the application that others can, by applying knowledge within the skill of the relevant art(s) (including the contents of the documents cited and incorporated by reference herein), readily modify and/or adapt for various applications such specific implementations, without undue experimentation, without departing from the general concept of the present application. Such adaptations and modifications are therefore intended to be within the meaning and range of equivalents of the disclosed implementations, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various implementations of the present application have been described above, it should be understood that they have been presented by way of example, and not limitation. It would be apparent to one skilled in the relevant art(s) that various changes in form and detail could be made therein without departing from the spirit and scope of the application. Thus, the present application should not be limited by any of the above-described example implementations.

What is claimed is:

1. A rotary cutter with a knife holder, comprising:
a cylinder having an outer surface and having an aperture defined about a perimeter of the cylinder, the aperture being defined a bearing wall, a backing wall, and a footing surface; and
a wedge block having a top face and a bottom face, the wedge block being disposed in the aperture with the bottom face of the wedge block seated adjacent the footing surface;
wherein at least one of the bottom face of the wedge block is angled with respect to the top face such that the bottom face and the top face are non-parallel, or the footing surface is angled with respect to the backing wall such that the foot surface and the backing wall are non-perpendicular, such that movement of the wedge block side-to-side with respect to the backing wall within the aperture is configured to cause a knife blade seated on the top surface of the wedge block to move vertically with respect to the outer surface of the cylinder.

2. The cutter of claim 1, wherein both the bottom face of the wedge block and the footing surface are angled.

3. The cutter of claim 1, further including an adjustment screw coupled to the wedge block, wherein rotation of the adjustment screw is configured to cause side to side motion of the wedge block with respect to the backing wall.

4. The cutter of claim 1, wherein the aperture further includes a recess and a well, wherein the recess and the well define areas to receive at least a portion of the wedge block in side-to-side adjustment positions.

5. The cutter of claim 4, wherein the well extends horizontally and downwardly from the footing surface.

6. The cutter of claim 4, wherein the recess extends horizontally and at least upwardly from the footing surface.

7. The cutter of claim 1, wherein the wedge block further includes an elongated hole sized and shaped to receive a fastener, wherein the elongated holes permit side-to-side movement of the wedge block in a first adjustment condition, and wherein the fastener is configured to secure the wedge block from movement in a second set condition.

8. A method of setting a knife height in a cylinder of a rotary cutter, comprising the steps of:
inserting a wedge block into an aperture in the cylinder, the wedge block having a top face and a bottom face, and the aperture being defined a bearing wall, a backing wall, and a footing surface, wherein at least one of the bottom face of the wedge block is angled with respect to the top face such that the bottom face and the top face are non-parallel, or the footing surface is angled with respect to the backing wall such that the foot surface and the backing wall are non-perpendicular;
seating the bottom face of the wedge block adjacent the footing surface of the aperture;
adjusting the side-to-side position of the wedge block with respect to the backing wall within the aperture to cause a knife blade seated on the top surface of the wedge block and extending at least partially past an outer surface of the cylinder to move vertically with respect to the outer surface of the cylinder;
securing the wedge block within the aperture once a desired vertical position of the knife blade is achieved; and
securing the knife blade within the aperture.
